(19) United States
(12) Patent Application Publication
(10) Pub. No.: US 2007/0127975 A1
(43) Pub. Date: Jun. 7, 2007

(54) CLIP WITH SLIDABLE MEMBER

(76) Inventor: Carl Cetera, Tenafly, NJ (US)

Correspondence Address: THE SONI LAW FIRM, 55 S. LAKE AVE SUITE 720, PASADENA, CA, 91101, US

(21) Appl. No.: 11/622,444

(22) Filed: Jan. 11, 2007

Related U.S. Application Data
(63) Continuation-in-part of application No. 10/764,029, filed on Jan. 22, 2004, now Pat. No. 7,179,004.

(51) Int. Cl. B43K 25/00; B43K 23/02

(52) U.S. Cl. 401/131; 24/11 R

(57) ABSTRACT

A clip comprising at least one pair of parallel rails having a slidable member connected thereon is disclosed. The clip may be attached to, for example, a handheld instrument, such as a pen. The slidable member moves along the rails by a user's finger manipulation, stimulating the tactile senses of the user, and allowing the user to dispel nervous tension. Indicia, such as advertising, may be placed upon the slidable member. Also disclosed is a method of advertising and promotion in which the slidable member is used as a vehicle for advertising.

### CROSS REFERENCE TO RELATED APPLICATIONS

This application is a continuation-in-part of application Ser. No. 10/764,029, filed on Jan. 22, 2004, which is hereby incorporated by reference.

### BACKGROUND OF THE INVENTION

1. Field of the Invention

The present invention relates to a clip for an elongated handheld instrument. More specifically, the present invention relates to a slidable member placed upon the clip of a handheld instrument, for example, a writing instrument. Moreover, the present invention relates to placing advertising upon a pen clip designed to effectively attract the attention of a consumer.

2. Description of the Prior Art

Clips upon writing instruments have been common for almost a century. It is also well known that advertising can be put upon writing instruments to get the attention of consumers. The advertising has taken the form of printing upon a pen barrel or clip. Such advertising has the disadvantage of utilizing only the visual sense for attracting the attention of a person, for example the consumer. There has not been any significant appeal to the other senses, for example, the kinesthetic sensation of touch, to attract the attention of the consumer to the advertising.

It is also well known that many individuals have a nervous habit of clicking a pen or mechanical pencil mechanism in order to relieve emotional stress. Although this habit may provide some stress relief, it has the disadvantage of wearing upon the mechanism of the writing instrument itself.

### SUMMARY OF THE INVENTION

One of the advantages of the present invention is to provide a clip with advertising for use upon a handheld instrument, for example a writing instrument, where the clip appeals not only to the visual senses, but also to the sensation of touch and movement. The clip, and more particularly, the advertising, will get markedly more attention by the consumer than a stationary advertising imprint.

It is also advantageous to provide a handheld writing instrument that incorporates a mechanism with a movable member that can help relieve nervous stress without wearing upon the pen writing tip extension mechanism.

The advantages of this invention are seen in this innovative type of clip that has a slidable member articulated into the clip. Furthermore, by providing this slidable member upon the clip, a person, such as a consumer, will pay more attention to the advertising while fidgeting, tinkering, or playing with the movable member on the clip. This device appeals not only to the visual sense, but also the tactile sense of the consumer, thus attracting the attention of the consumer to the advertising or logo placed upon the slidable member. This is an advantage over the prior known methods of advertising, which uses only stationary imprints and inserts, because the eye will be naturally drawn to the movement of the sliding clip member.

Furthermore, this device helps the user dissipate nervous stress without wearing away upon the pen mechanism itself. Many pens have been worn into exhaustion by the repeated clicking of the pen cartridge mechanism by an anxious or frustrated worker or student. The slidable member permits the user of the writing instrument to place wear only upon the clip and not upon the cartridge mechanism. Another advantage of this slidable clip is that it is inexpensive to produce.

The handheld instrument of the present invention is comprised of an elongated body connected with a clip. The clip comprises an essentially rectangular shaped wire having two parallel rails that are connected together at an end, and a slidable member slidably connected to the rails. In one embodiment, the slidable member may be comprised of a lower segment, an upper segment, and a middle segment where the middle segment is smaller in diameter than the lower segment and upper segment so that the middle segment may fit between the two parallel rails. The slidable member articulates with the rails such that it is movable upwardly and downwardly some distance along the rails between the upper and the lower end of said clip. In another embodiment, the slidable member may be comprised of two segments where a lower segment is smaller in diameter than an upper segment and the rails are connected to the lower segment via channels formed on the lower segment. In still another embodiment, the slidable member may be formed as a single piece with holes to engage therein the rails. It is understood that further embodiments are anticipated from this design that allows the slidable member to articulate with the rails. It is also understood that the slidable member itself may take the form of various shapes such as square, round, triangular, and others including those that are unique to an advertiser's logo. It is further understood that other types of mechanical and/or electrical devices may be attached to the slidable member itself including laser pointers and other compact devices that may be integrated with the slidable member while retaining mobility along the rails.

### BRIEF DESCRIPTION OF THE DRAWINGS

FIG. 1 is a perspective view of a handheld writing instrument in accordance with the present invention;

FIG. 2 is a side elevational view of a handheld writing instrument in accordance with the present invention;

FIG. 3 is a side elevational view of the slidable member in the first preferred embodiment of the present invention;

FIG. 4 is a top plan view of the slidable member in the first preferred embodiment of the present invention;

FIG. 5 is a side cross sectional view of the slidable member in the first preferred embodiment of the present invention;

FIG. 6 is a side cross sectional view of the slidable member as a variation of the first preferred embodiment of the present invention;

FIG. 7 is a side cross sectional view of the slidable member in the second preferred embodiment of the present invention;

FIG. 7A is a perspective view of a handheld writing instrument in the second preferred embodiment of the present invention;

FIG. 8 is a side cross sectional view of the slidable member as a variation of the second preferred embodiment of the present invention;

FIG. 9 is a side cross sectional view of the slidable member as another variation of the second preferred embodiment of the present invention;

FIG. 10 is a side cross sectional view of the slidable member in the third preferred embodiment of the present invention; and

FIG. 11 is a side cross sectional view of the slidable member as a variation of the third preferred embodiment of the present invention.

### DETAILED DESCRIPTION OF THE PREFERRED EMBODIMENT

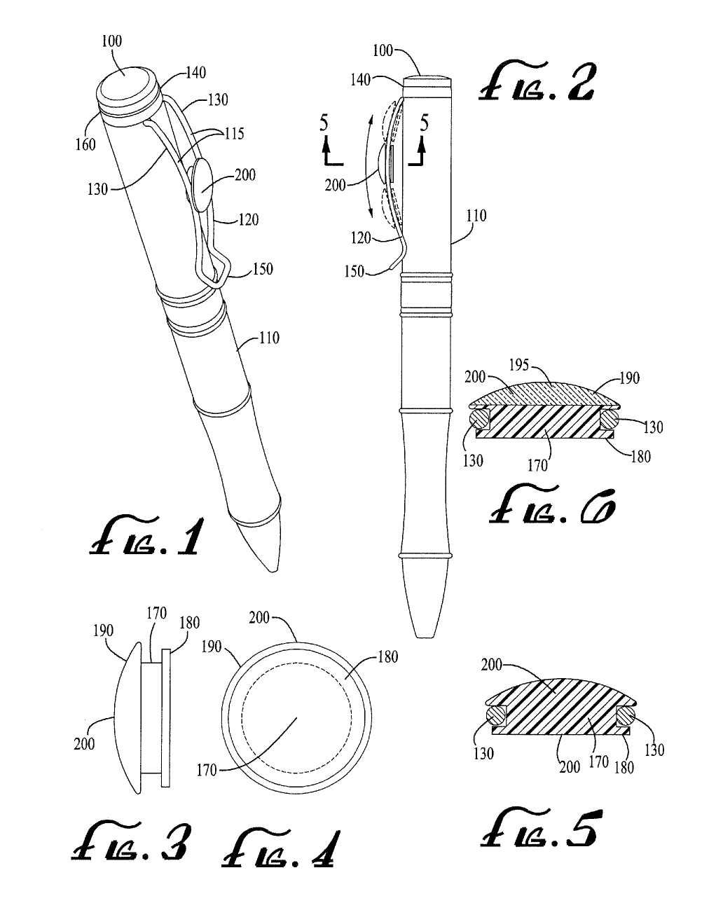

Referring now more specifically to the drawings, FIGS. 1 and 2 show the preferred embodiment of handheld writing instrument 100 in the present invention, which comprises an elongated instrument body 110 and a clip 120. The handheld instrument 100 in the preferred embodiment is a pen or other suitable handheld writing instrument. However, such handheld instruments may also include, but are not limited to, for example, a laser pointer, PDA stylus, handheld pocket tool, or pocket knife. The clip 120 comprises at least one pair of parallel rails 130. A slidable member 200 is slidably connected with the rails 130 during assembly, and configured such that during the contemplated use of the invention, it is easily slidable to and pro along a substantial portion of the rails at ordinary strength of finger force of a user. Further, the rails 130 are positioned high enough upon the handheld instrument body 110 so that there is sufficient clearance between the slidable member 200 and the handheld instrument body 110 to permit free movement of the slidable member 200. The user of the instrument 100 may fidget, play, squirm, wiggle, twitch, fuss, jitter, worry, tinker, putter, and fool with the slidable member 200, moving it easily up and down the rails 130.

As may be seen in FIGS. 1 and 2, in the preferred embodiment, the at least one pair of rails 130 may be essentially rectangular shaped, and has an upper clip end 140 and a lower clip end 150. The lower clip end 150 connects the parallel rails 130 together, forming generally a rectangular or a U-shape in the preferred embodiment, so that the slidable member 200 may not slip off of the lower clip end 150. The connected lower clip end may, however, form other geometrical shapes. The lower clip end 150 is generally biased against or toward the instrument body 110 so that the handheld instrument 100 may be clipped into, for example, a pocket via the lower clip end 150. The upper clip end 140 connects the clip 120 to the elongated instrument body 110.

In this preferred embodiment, the rails 130 are formed as metal wire with suitable elasticity, rigidity, and diameter to prevent the two parallel rails 130 from being spread apart during routine movements of the slidable member 200. In some embodiments, the rails 130 may be manufactured from plastic or other suitable materials, still in a wire shape. Further, the rails may be plated, for example with chrome, to give the clip 120 a more expensive and pleasing appearance.

FIG. 2 shows how the slidable member 200 moves upwardly and downwardly between the upper clip end 140 and lower clip end 150 upon the parallel rails. Also in the preferred embodiment, there is a slight bend near the lower clip end 150 in the direction away from the body 110 of the handheld instrument 100, defining an angle in the range of 0 degrees to 45 degrees with respect to the body 110, allowing easier insertion of the instrument 100 into a shirt pocket or other anchoring location. The part of the clip that is so bent defines a clipping portion of the clip 120 that is biased toward the instrument body 110, and also forms a lower bound of the rails up to which the slidable member 200 can slide down.

The anchoring of the upper clip end 140 of the clip 120 to the handheld instrument body 110 may be via a pen cap 160 as shown in FIGS. 1 and 2, or via any one of many currently known means readily recognized by one skilled in the art. Such means may include, for example, a loop encircling the body 110 of the handheld instrument 100, direct insertion of the upper clip end 140 of the clip 120 into holes drilled in the pen body 110 as shown in FIG. 1, or by bending of the upper end 140 of the clip 120 over the top of the handheld instrument 100 and securing the upper end 140 with a cap.

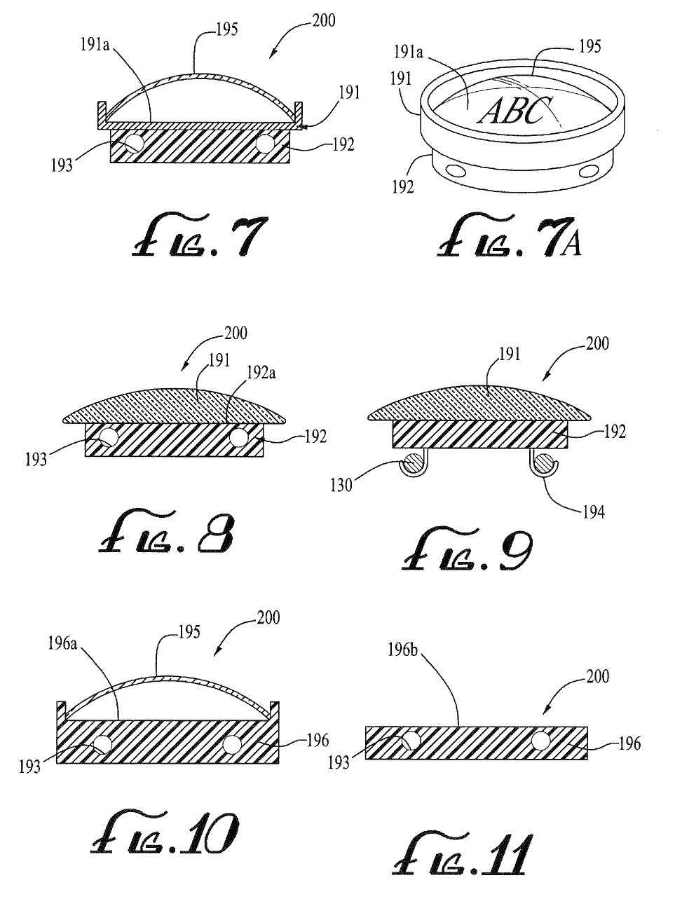

The slidable member 200 may take any geometrical shape, not limited to the circular shape shown in FIGS. 1-9, and is suitably sized for a user's finger to easily and comfortably play with it. FIGS. 3-6 describe the slidable member 200 in the first preferred embodiment of the present invention in which the slidable member 200 comprises three segments. The lower segment 180 is most proximal to the elongated instrument body 110, and the upper segment 190 is the most distal from the elongated instrument body 110. The diameter of both the lower segment 180 and the upper segment 190 is greater than the distance between the two parallel rails 130. Between the lower segment 180 and the upper segment 190 is a narrower middle segment 170 that fits between the two parallel rails 130. FIGS. 5 and 6 show how the slidable member 200 is securably retained upon the parallel rails 130 via the middle segment 170 while it slides along the parallel rails 130 from the upper clip end 140 to the lower clip end 150 without becoming dislodged. These various slidable member segments may be manufactured as separate pieces and then attached together, or the three segments may be formed in one piece as shown in FIG. 6 by, for example, an injection molding method. The slidable member 200 of the clip may comprise, for example metal, plastic, wood, ceramic, or other suitable materials known to those in the art.

In the first preferred embodiment of the slidable member 200 in the present invention depicted in FIGS. 3-6, there may be advertising indicia placed upon the upper segment 190 of the slidable member 200. This indicia for example may include, but not be limited to, a logo, trademark, advertisement, emblem, label, stamp, feature, brand, brand name, insignia, crest, token, seal, decal, pitch, announcement, slogan, monogram, or even a political message. Such indicia can also be a photo, design, or other pictorial representation. Furthermore, such indicia may be raised or textured to provide even more tactile sensory input to a user. This indicia may be printed on the outer surface of the upper segment 190, or alternatively, as shown in FIG. 6, may be imprinted upon the middle segment 170 and below the upper segment 190 which in itself forms a transparent outer covering, whereby the indicia is visible but less likely to wear off over time. Such indicia, coupled with the movement of the slidable member 200 markedly increases the attention of the consumer to advertising.

FIGS. 7-9 and 7A shows the second preferred embodiment of the slidable member 200 in the present invention, in which the slidable member 200 is comprised of two segments, the upper segment 191 and the lower segment 192. The slidable member 200 is slidably connected to the parallel rails via two channels formed, preferably, on the lower segment 192. Those channels could be two holes 193 drilled through the lower segment 192, as shown in FIGS. 7, 7A, and 8, into which the wires of the rails are inserted, or could take other forms, for example, two semi-cylindrical ducts 194 attached to, preferably, the lower segment 192 to accommodate the rails 130 as shown in FIG. 9. The advertising indicia could be imprinted upon the top surface of the upper segment 191. For example, as shown in FIGS. 7 and 7A, the upper segment 191 may define a recess 191a in the center thereof, on which advertising indicia is imprinted, being covered by a transparent cover 195 to protect against wear off. FIG. 8 shows a variation of the second preferred embodiment, in which the advertising indicia is imprinted (not shown) on the surface 192a between the lower segment 192 and the upper segment 191 where the upper segment 191 itself may form a transparent covering.

FIGS. 10 and 11 show the third preferred embodiment of the slidable member 200, in which the slidable member could be formed as one solid piece having two channels for accepting the parallel wire rails. Those channels could be two holes 193 drilled through the single piece body 196 as shown in FIG. 10, but other types of channels, such as semi-cylindrical ducts attached to the body 196 (not shown), as similar to those in FIG. 9, are also within the contemplated scope of the present invention. The single piece body 196 of the slidable member 200 may have a recessed top surface 196a as shown in FIG. 10, or a generally flat top surface 196b as shown in FIG. 11. Preferably, each top surface 196a and 196b may have advertising indicia imprinted on it, further being covered by a transparent cover 195.

Other embodiments of the present invention will be also readily recognized by those skilled in the art. For example in one embodiment, the clip may form, instead of parallel rails, a substantially flat solid strip. In such an embodiment, the slidable member may be comprised of only a single segment which is then fitted and slidably articulated with the substantially flat solid strip via, for example, hooks that wrap around the strip. In yet another embodiment, the clip may be a substantially flat solid strip with a narrow slot cut into, and defined along, the longitudinal axis of the solid flat strip. In such an embodiment, the slidable member could still be comprised of three segments as in the first preferred embodiment described in FIG. 3 where the middle segment of the slidable member is sized so that it may fit in, and slide within, the slot.

Further, the slidable member 200 may be designed, in one embodiment, so that it cannot be voluntarily removed from between the rails 130 without destroying the clip 120. This prevents the user from removing the advertising indicia. However, in another embodiments, the slidable member 200 may be made so that it can be voluntarily and easily removed from, or reconnected between, the rails 130. This may be accomplished, for example in the first preferred embodiment described above, by having the lower segment 180 or upper segment 190 of the slidable member 200 detachable from the middle segment 170. Methods for doing this, for example by means of a snap, screw, or twisting mechanism, would be recognized by those skilled in the art. The slidable member 200 can then be freely exchanged for one with a different indicia or picture.

It is also contemplated in the present invention that more than one slidable member could be attached on one pen. For example, two or more slidable members, each with different advertising indicia, may be connected to the clip.

Since the sliding movement of the slidable member easily attracts the attention of not only the user but also other viewers, the present invention can act as an effective vehicle for advertising or promotion. Therefore, the present invention also contemplates such a method for advertising or promotion, which comprises preparing a writing instrument with a railed clip having a slidable member connected thereon, and imprinting advertising material on an outer surface of the slidable member.

The present invention may be embodied in other specific forms without departing from the essential spirit or attributes thereof. It is desired that the embodiments described herein be considered in all respects as illustrative, not restrictive, and that reference be made to the appended claims for determining the scope of the invention.

What is claimed is:

1. A clip for a handheld instrument, said clip having an upper clip end and an opposing lower clip end, said clip comprising:
a) at least one pair of parallel rails having a sliding rail portion thereon of a fixed length defined by the distance between an upper sliding position proximate the upper clip end and a lower sliding position proximate the lower clip end; and
b) a slidable member connected with said at least one pair of parallel rails and configured such that said member is movable upwardly and downwardly along the entire length of the sliding rail portion.

2. The clip as in claim 1, wherein said slidable member is configured to be detachable from and reconnectible with said at least one pair of rails.

3. The clip as in claim 1, wherein said at least one pair of rails are formed as metal wires.

4. The clip as in claim 3, wherein said at least one pair of rails are connected at the lower clip end thereof.

5. The clip as in claim 4, wherein said at least one pair of rails extends from the upper clip end toward the lower clip end and is substantially curved toward a first inward direction, said at least one pair of rails defining a bend at a portion proximate the lower clip end and extending away therefrom in a second outward direction to form a clipping rail portion thereat.

6. The clip as in claim 5, wherein said clipping rail portion defines the lower sliding position.

7. The clip as in claim 4, wherein said slidable member defines two channels configured to receive said at least one pair of rails therethrough.

8. The clip as in claim 7, wherein said slidable member comprises a lower segment and an upper segment superimposed thereon having a larger width than said lower segment.

9. The clip as in claim 8, wherein said two channels are formed as two cylindrical holes extending through said lower segment.

10. The clip as in claim 8, wherein said segments are integrally formed as a single piece of plastic.

11. The clip as in claim 8, wherein said segments are integrally formed as a single piece of metal.

12. The clip as in claim 8, wherein said slidable member further comprises advertising indicia imprinted on a surface between said upper and lower segments, and said upper segment is fabricated from transparent material such that said indicia is visible therethrough.

13. The clip as in claim 8, wherein said slidable member further comprises advertising indicia imprinted on a top surface of said upper segment distal to said lower segment.

14. The clip as in claim 13, wherein said upper segment defines on the top surface thereof a recess on which said advertising indicia is imprinted, and further comprises a transparent cover disposed upon the top surface thereof for protecting said advertising indicia.

15. The clip as in claim 13, wherein said indicia is imprinted with three dimensional textures for providing sensory input thereby.

16. The clip as in claim 7, wherein said slidable member comprises a single segment and advertising indicia imprinted to an outer surface of said single segment.

17. The clip as in claim 16, wherein said single segment defines, on a top surface thereof distal to said at least one pair of rails, a recess on which said advertising indicia is imprinted, and further comprises a transparent cover disposed upon the top surface of said single segment for protecting said advertising indicia.

18. A handheld instrument comprising:
a) an elongated instrument body;
b) a clip having an upper clip end and an opposing lower clip end, the upper clip end being connected with said elongated instrument body, said clip comprising at least one pair of parallel rails having a sliding rail portion thereon of a fixed length defined by the distance between an upper sliding position proximate the upper clip end and a lower sliding position proximate the lower clip end; and
c) a slidable member connected with said at least one pair of parallel rails and configured such that said member is movable upwardly and downwardly along the entire length of the sliding rail portion.

19. The handheld instrument as in claim 18, wherein said slidable member is configured to be detachable from and reconnectible with said at least one pair of rails.

20. The handheld instrument as in claim 18, wherein said at least one pair of rails are formed as metal wires.

21. The handheld instrument as in claim 20, wherein said at least one pair of rails are connected at the lower clip end thereof.

22. The handheld instrument as in claim 21, wherein said at least one pair of rails extends from the upper clip end toward the lower clip end and is substantially curved toward a first inward direction, said at least one pair of rails defining a bend at a portion proximate the lower clip end and extending away therefrom in a second outward direction to form a clipping rail portion thereat.

23. The handheld instrument as in claim 22, wherein said clipping rail portion defines the lower sliding position.

24. The handheld instrument as in claim 21, wherein said slidable member defines two channels configured to receive said at least one pair of rails therethrough.

25. The handheld instrument as in claim 24, wherein said slidable member comprises a lower segment and an upper segment superimposed thereon having a larger width than said lower segment.

26. The handheld instrument as in claim 25, wherein said two channels are formed as two cylindrical holes extending through said lower segment.

27. The handheld instrument as in claim 25, wherein said segments are integrally formed as a single piece of plastic.

28. The handheld instrument as in claim 25, wherein said segments are integrally formed as a single piece of metal.

29. The handheld instrument as in claim 25, wherein said slidable member further comprises advertising indicia imprinted on a surface between said upper and lower segments, and said upper segment is fabricated from transparent material such that said indicia is visible therethrough.

30. The handheld instrument as in claim 25, wherein said slidable member further comprises advertising indicia imprinted on a top surface of said upper segment distal to said lower segment.

31. The handheld instrument as in claim 30, wherein said upper segment defines on the top surface thereof a recess on which said advertising indicia is imprinted, and further comprises a transparent cover disposed upon the top surface thereof for protecting said advertising indicia.

32. The handheld instrument as in claim 30, wherein said indicia is imprinted with three dimensional textures for providing sensory input thereby.

33. The handheld instrument as in claim 24, wherein said slidable member comprises a single segment and advertising indicia imprinted to an outer surface of said single segment.

34. The handheld instrument as in claim 33, wherein said single segment defines, on a top surface thereof disposed distal to said at least one pair of rails, a recess on which said advertising indicia is imprinted, and further comprises a transparent cover disposed upon the top surface of said single segment for protecting said advertising indicia.

35. The handheld instrument as in claim 18, wherein said handheld instrument is a writing instrument.

36. A method of advertising comprising the steps of:
a) providing a clip for a handheld instrument, which has upper and opposing lower clip ends and comprises at least one pair of parallel rails having a sliding rail portion thereon of a fixed length defined by the distance between an upper sliding position proximate the upper clip end and a lower sliding position proximate the lower clip end, and a slidable member connected with the at least one pair of parallel rails and configured such that the slidable member is movable upwardly and downwardly along the entire length of the sliding rail portion; and
b) imprinting advertising material on at least one visible surface of the sliding member.
